(19) United States
(12) Patent Application Publication
(10) Pub. No.: US 2017/0181021 A1
(43) Pub. Date: Jun. 22, 2017

(54) METHOD AND APPARATUS FOR MANAGING MOBILITY BETWEEN HETEROGENEOUS NETWORKS

(71) Applicant: ELECTRONICS AND TELECOMMUNICATIONS RESEARCH INSTITUTE, Daejeon (KR)

(72) Inventors: Byungsik YOON, Daejeon (KR); Yong Seouk CHOI, Daejeon (KR)

(21) Appl. No.: 15/381,385

(22) Filed: Dec. 16, 2016

(30) Foreign Application Priority Data
Dec. 16, 2015 (KR) 10-2015-0180495
Dec. 15, 2016 (KR) 10-2016-0171979

(51) Int. Cl. H04W 24/08; H04W 28/02; H04W 24/10

(52) U.S. Cl. CPC H04W 24/08; H04W 24/10; H04W 28/0289; H04W 28/0268

(57) ABSTRACT

A method and an apparatus for managing mobility of a terminal between heterogeneous networks. The method includes: generating applications each corresponding to a plurality of terminals and data units (DUs) of a plurality of heterogeneous networks using software defined network (SDN) technology; collecting radio channel measurement data on channels of radio networks from the plurality of terminals through terminal applications corresponding to the plurality of terminals; collecting an average value of radio resources used in radio units (RUs) of the plurality of heterogeneous networks and network congestion data of the RUs of the plurality of heterogeneous networks through DU applications corresponding to the DUs of the plurality of heterogeneous networks; and determining whether or not to change networks of the plurality of terminals on the basis of the radio channel measurement data, the average value of the radio resources, and the network congestion data.

### CROSS-REFERENCE TO RELATED APPLICATION(S)

This application claims priority to and the benefit of Korean Patent Application Nos. 10-2015-0180495 and 10-2016-0171979, filed in the Korean Intellectual Property Office on Dec. 16, 2015, and Dec. 15, 2016, the entire contents of which are incorporated herein by reference.

### BACKGROUND OF THE INVENTION

1. Field of the Invention

The present invention relates to a method and an apparatus for managing mobility of a terminal between heterogeneous networks.

2. Description of Related Art

Recently, in accordance with a rapid increase in an amount of data transmitted and received in a radio mobile communication network and diversification of kinds of data, an existing network has reached a structural limit in processing surging data. An existing access network such as a code division multiple access (CDMA) network, a long term evolution (LTE) network is operated in a kind of distributed control communication scheme. That is, radio resources, security, signal interference, and the like, may be managed in the respective base stations that are independently distributed. This scheme has an advantage in configuring and operating a single kind of few base stations. However, this scheme is not efficient in the future heterogeneous network radio communication convergence environment in which a capacity is increased, various kinds of packets should be processed, and various kinds of radio communication systems are disposed.

In order to solve this problem, software defined network (SDN) and network function virtualization (NFV) technology capable of flexibly configuring a network at a high performance has been suggested as an alternative. Existing radio access functions may be separated or configured in a centralized scheme on the basis of the SDN and NFV technology. In addition, main functions of a radio access network are implemented by software, and may be implemented on the basis of virtualized resources.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for managing mobility of a terminal between heterogeneous networks on the basis of software defined network (SDN) technology. Further, the present invention has been made in an effort to provide a heterogeneous network base station for managing mobility of a terminal between heterogeneous networks on the basis of SDN technology. Further, the present invention has been made in an effort to provide an apparatus for managing mobility of a terminal between heterogeneous networks on the basis of SDN and network function virtualization (NFV) technology.

An exemplary embodiment provides a method for managing mobility of a terminal between heterogeneous networks, including: generating applications each corresponding to a plurality of terminals and data units (DUs) of a plurality of heterogeneous networks using software defined network (SDN) technology; collecting radio channel measurement data on channels of radio networks from the plurality of terminals through terminal applications corresponding to the plurality of terminals; collecting an average value of radio resources used in radio units (RUs) of the plurality of heterogeneous networks and network congestion data of the RUs of the plurality of heterogeneous networks through DU applications corresponding to the DUs of the plurality of heterogeneous networks; and determining whether or not to change networks of the plurality of terminals on the basis of the radio channel measurement data, the average value of the radio resources, and the network congestion data.

The determining of whether or not to change the networks may include referring to inspection results of packets transmitted to the plurality of terminals.

The determining of whether or not to change the networks may include referring to a situation of a network currently connected to one of the plurality of terminals and situations of other networks in a zone in which the plurality of terminals are positioned on the basis of the network congestion data.

The method for managing mobility may further include: after the determining of whether or not to change the networks, instructing a first terminal that is to change a network among the plurality of terminals to change the network into an optimal network on the basis of subscriber information and an optimal path of the first terminal.

The method for managing mobility may further include: after the determining of whether or not to change the networks, adjusting a quality of service (QoS) control scheme to a QoS control scheme of a new network into which the network is to be changed.

The method for managing mobility may further include: after the determining of whether or not to change the networks, adding a network path of a network different from a network currently connected to a first terminal that is to change a network among the plurality of terminals with respect to the first terminal.

Another exemplary embodiment provides heterogeneous network base station including: a processor, a memory, and a radio frequency unit, wherein the processor executes a program stored in the memory to perform the following steps: generating applications each corresponding to a plurality of terminals and DUs of a plurality of heterogeneous networks using SDN technology; collecting radio channel measurement data on channels of radio networks from the plurality of terminals through terminal applications corresponding to the plurality of terminals; collecting an average value of radio resources used in RUs of the plurality of heterogeneous networks and network congestion data of the RUs of the plurality of heterogeneous networks through DU applications corresponding to the DUs of the plurality of heterogeneous networks; and determining whether or not to change networks of the plurality of terminals on the basis of the radio channel measurement data, the average value of the radio resources, and the network congestion data.

When the processor performs the determining of whether or not to change the networks, the processor may perform the following step: referring to inspection results of packets transmitted to the plurality of terminals.

When the processor performs the determining of whether or not to change the networks, the processor may perform the following step: referring to a situation of a network currently connected to one of the plurality of terminals and situations of other networks in a zone in which the plurality of terminals are positioned on the basis of the network congestion data.

The processor may execute the program to further perform the following step: after the determining of whether or not to change the networks, instructing a first terminal that is to change a network among the plurality of terminals to change the network into an optimal network on the basis of subscriber information and an optimal path of the first terminal.

The processor may execute the program to further perform the following step: after the determining of whether or not to change the networks, adjusting a QoS control scheme to a QoS control scheme of a new network into which the network is to be changed.

The processor may execute the program to further perform the following step: after the determining of whether or not to change the networks, adding a network path of a network different from a network currently connected to a first terminal that is to change a network among the plurality of terminals with respect to the first terminal.

Yet another exemplary embodiment provides an apparatus for managing mobility of a terminal between heterogeneous networks, including: a network function virtualization (NFV) infrastructure layer connecting a plurality of hardware resources including computing hardware, storage hardware, and network hardware and a plurality of virtual network functions (VNFs) including virtual computing, a virtual storage, and a virtual network to each other through a virtualization layer to virtualize network functions; an application layer including applications each corresponding to a plurality of terminals and DUs of a plurality of heterogeneous networks using SDN technology; and a virtual network functions (VNFs) layer performing interfacing between the NFV infrastructure layer and the application layer, wherein the application layer includes: a heterogeneous network resource management entity collecting radio channel measurement data on channels of radio networks from the plurality of terminals through terminal applications corresponding to the plurality of terminals and collecting an average value of radio resources used in radio units (RUs) of the plurality of heterogeneous networks and network congestion data of the RUs of the plurality of heterogeneous networks through DU applications corresponding to the DUs of the plurality of heterogeneous networks; and a heterogeneous network mobility management entity determining whether or not to change networks of the plurality of terminals on the basis of the radio channel measurement data, the average value of the radio resources, and the network congestion data.

The heterogeneous network mobility management entity may determine whether or not to change the networks with reference to inspection results of packets transmitted to the plurality of terminals.

The heterogeneous network mobility management entity may determine whether or not to change the networks with reference to a situation of a network currently connected to one of the plurality of terminals and situations of other networks in a zone in which the plurality of terminals are positioned on the basis of the network congestion data.

The heterogeneous network mobility management entity, after the determining of whether or not to change the networks, may instruct a first terminal that is to change a network among the plurality of terminals to change the network into an optimal network on the basis of subscriber information and an optimal path of the first terminal.

The heterogeneous network mobility management entity, after the determining of whether or not to change the networks, may adjust a QoS control scheme to a QoS control scheme of a new network into which the network is to be changed.

The heterogeneous network mobility management entity, after the determining of whether or not to change the networks, may add a network path of a network different from a network currently connected to a first terminal that is to change a network among the plurality of terminals with respect to the first terminal.

### BRIEF DESCRIPTION OF THE DRAWINGS

FIG. 1 is a view schematically showing a heterogeneous network convergence network according to an exemplary embodiment.

FIG. 2 is a block diagram schematically showing a heterogeneous network base station, a radio unit (RU), and a core network (CN) of the heterogeneous network convergence network according to an exemplary embodiment.

FIG. 3 is a schematic view showing a method for managing mobility of a terminal of a heterogeneous network base station according to an exemplary embodiment.

FIG. 4 is a flow chart showing the method for managing mobility of a terminal of a heterogeneous network base station according to an exemplary embodiment.

FIG. 5 is a block diagram showing a radio communication system according to an exemplary embodiment.

### DETAILED DESCRIPTION OF THE EMBODIMENTS

Hereinafter, exemplary embodiments of the present invention will be described in detail with reference to the accompanying drawings so as to be easily practiced by those skilled in the art to which the present invention pertains. However, the present invention may be modified in various different forms, and is not limited to exemplary embodiments provided in the present specification. In addition, components unrelated to a description will be omitted in the accompanying drawings in order to clearly describe the present invention, and similar reference numerals will be used to denote similar components throughout the present specification.

Throughout the present specification, a terminal may indicate a mobile station (MS), a mobile terminal (MT), an advanced mobile station (AMS), a high reliability mobile station (HR-MS), a subscriber station (SS), a portable subscriber station (PSS), an access terminal (AT), a user equipment (UE), a machine type communication (MTC) device, and the like, and may include all or some of functions of the MT, the MS, the AMS, the HR-MS, the SS, the PSS, the AT, the UE, and the like.

In addition, a base station (BS) may indicate an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as the base station, a relay node (RN) serving as the base station, an advanced relay station (ARS) serving as the base station, a high reliability relay station (HR-RS) serving as the base station, small base stations [femto base station (femto BS), a home node B (HNB), a home eNodeB (HeNB), a pico base station (pico BS), a macro base station (macro BS), a micro base station (micro BS), and the like], or the like, and may include all or some of functions of the ABS, the node B, the eNodeB, the AP, the RAS, the BTS, the MMR-BS, the RS, the RN, the ARS, the HR-RS, the small base stations, or the like.

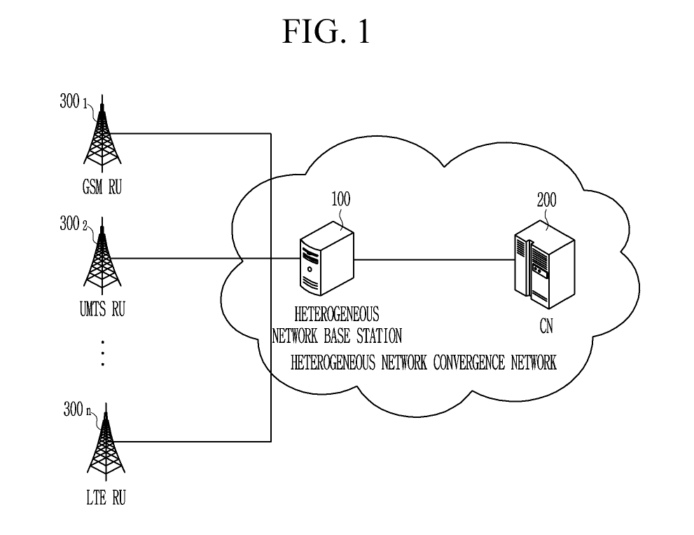

FIG. 1 is a view schematically showing a heterogeneous network convergence network according to an exemplary embodiment.

In accordance with an increase in utilization and a service demand of a mobile communication network, various heterogeneous communication networks such as a global system for mobile communications (GSM), a wideband code division multiple access (WCDMA), a long term evolution (LTE), a worldwide interoperability for microwave access (WiMAX), and the like, have been densely installed in the same regional position, and the respective mobile communication networks have utilized various kinds of frequency resources. In the case in which the respective mobile communication networks are independently operated, interworking between heterogeneous mobile communication networks cannot but be restrictively performed through interworking equipment (for example, interworking functions (IWFs)) positioned outside structures of the respective mobile communication networks.

When development of a millimeter wave (mmWave)-based fifth generation (5G) mobile communication system is completed in the future, it is decided that a 5G mobile communication network will also closely cooperate with a conventional third generation (3G) or fourth generation (4G) mobile communication system. In addition, since one terminal may accommodate mobile communication specifications of multi-radio access technology (multi-RAT) or a multi-mode due to development of semiconductor integration technology, portions of a base station and a core network (CN) need to be effectively unified.

Referring to FIG. 1, radio units (RUs) 300 (for example, a GSM RU 300₁, a universal mobile telecommunications system (UMTS) RU 300₂, a mmWAVE RU 300ₙ₋₁, a LTE RU 300ₙ, and the like) wirelessly connected to terminals 10 of various mobile communication networks are connected to a heterogeneous network base station 100, and the heterogeneous network base station 100 is connected to a CN 200. Here, the CN is a common CN that may serve as a core network of various heterogeneous networks. Data units (DUs) of the respective mobile communication networks may be implemented on the basis of software using software defined network (SDN) and network function virtualization (NFV) environments within the heterogeneous network base station 100.

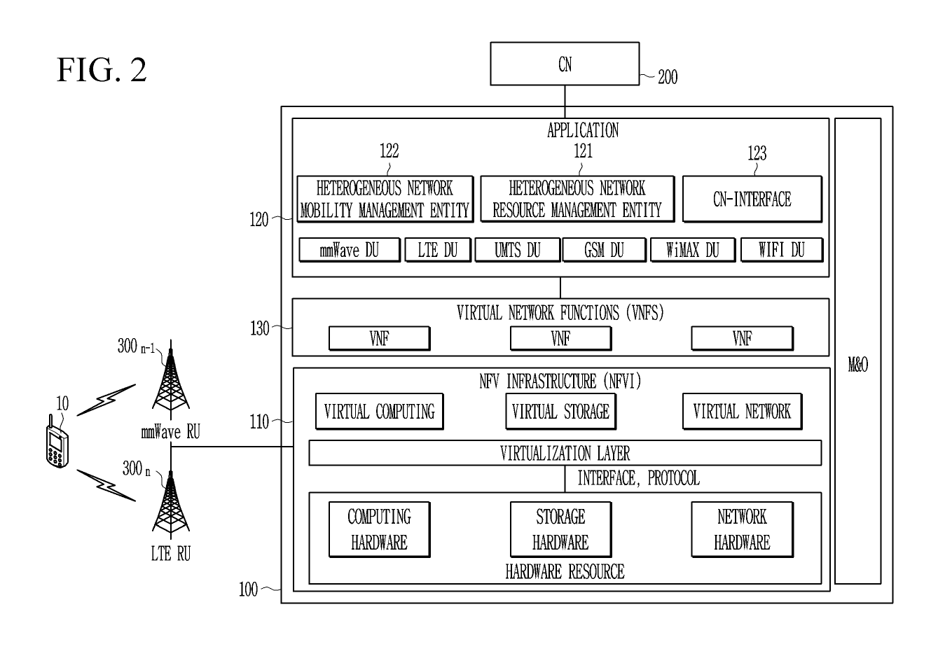

FIG. 2 is a block diagram schematically showing a heterogeneous network base station, an RU, and a CN of the heterogeneous network convergence network according to an exemplary embodiment.

Referring to FIG. 2, the heterogeneous network base station 100 according to an exemplary embodiment includes an NFV infrastructure (NFVI) layer 110, an application layer 120, and a virtual network functions (VNFs) layer 130 performing interfacing between the NFVI layer 110 and the application layer 120. In addition, referring to FIG. 2, the heterogeneous network base station 100 according to an exemplary embodiment may further include a management & orchestration (M&O) performing management and orchestration among the NFVI layer 110, the application layer 120, and the VNFs layer 130.

The NFVI layer 110 connects a plurality of hardware resources (computing hardware, storage hardware, and network hardware) and various virtual network functions (virtual computing, a virtual storage, a virtual network, and the like) to each other through a virtualization layer to virtualize network functions. The hardware resources of the NFVI layer 110 are connected to the RUs 300 directly and wirelessly connected to the terminal 10. That is, the hardware resources of the NFVI layer 110 may transfer signals of the terminal 10 received in the RUs 300 to a virtual network function of the NFVI layer 110, and the virtual network function may transfer signals of the application layer 120 to the RUs 300 through the hardware resources.

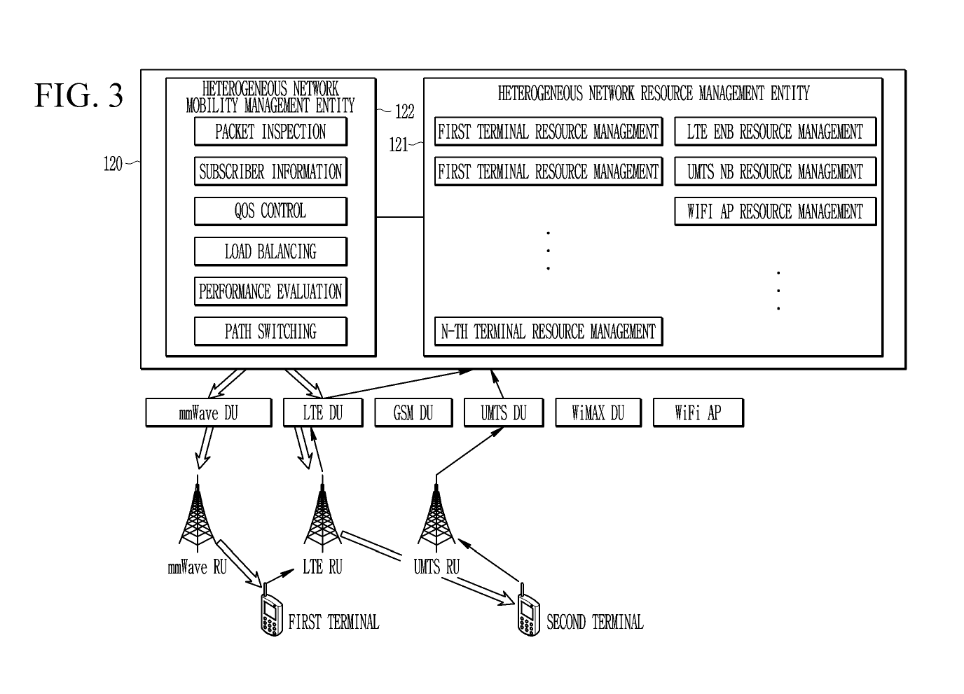

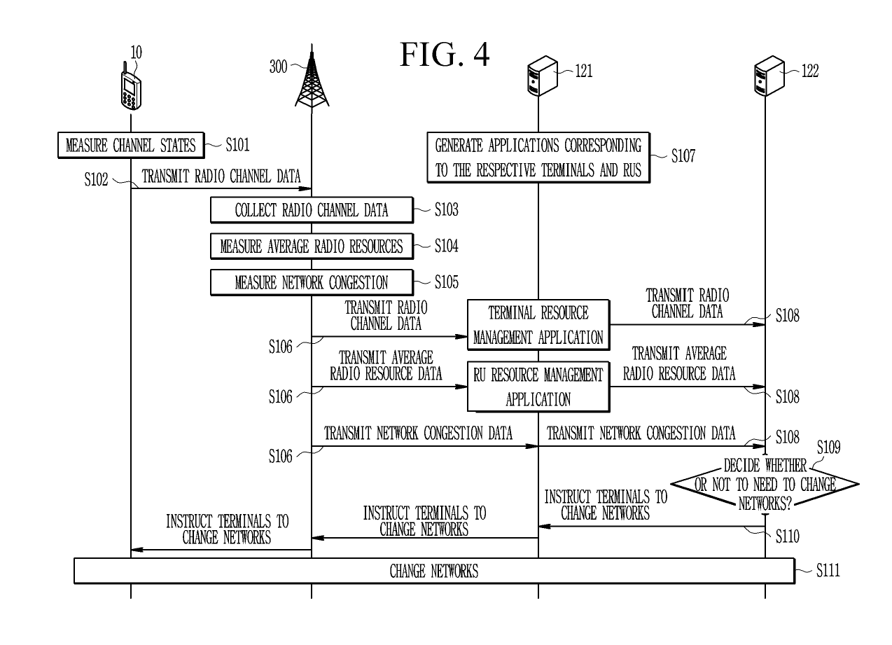

The application layer 120 includes DUs of the respective networks, a heterogeneous network resource management entity 121, and a heterogeneous network mobility management entity 122. In an exemplary embodiment, the DUs, the heterogeneous network resource management entity, and the heterogeneous network mobility management entity of the application layer 120 may be implemented using SDN technology within the application layer 120. The DUs of the application layer 120 may transmit and receive signals to and from the RUs 300 of a plurality of heterogeneous networks through the virtualized NFVI layer 110. A CN interface 123 of the application layer 120 is in charge of an interface with the CN 200 serving as a common core. Hereinafter, the heterogeneous network mobility management entity and the heterogeneous network resource management entity of the application layer 120 will be described in detail with reference to FIGS. 3 and 4.

FIG. 3 is a schematic view showing a method for managing mobility of a terminal of a heterogeneous network base station according to an exemplary embodiment, and FIG. 4 is a flow chart showing the method for managing mobility of a terminal of a heterogeneous network base station according to an exemplary embodiment.

Referring to FIG. 3, a first terminal and a second terminal periodically report accessible radio access schemes and states of accessed channels to RUs with which they are camping or are communicating. In FIG. 3, the first terminal and the second terminal include multi-mode and multi-radio access technology (RAT) functions, and an RU that is communicating with the first terminal is an LTE RU and an RU that is communicating with the second terminal 2 is a UMTS RU. Then, the reports of the accessible radio access schemes and the states of the accessed channels of the first terminal and the second terminal transferred from the LTE RU and the UMTS RU are transferred to the heterogeneous network resource management entity 121 through DUs (that is, an LTE DU and a UMTS DU) in the heterogeneous network base station 100 consisting of applications.

The heterogeneous network resource management entity 121 may manage performance of all of the terminals positioned in a specific zone, radio resources of all of the terminals, and performance of networks that the respective terminal access. That is, the heterogeneous network resource management entity 121 may collectively manage radio resources and network resources of a heterogeneous network radio communication convergence environment.

Then, the heterogeneous network mobility management entity 122 determines a network having a radio access scheme currently optimal for a terminal in consideration of the reports of the accessible radio access schemes and the states of the accessed channels of the first terminal and the second terminal transferred to the heterogeneous network resource management entity 121, radio resources of the RUs, network performance, and the like. The heterogeneous network mobility management entity 122 supports functions such as handover, dual connection, and the like, between heterogeneous networks.

The heterogeneous network mobility management entity 122 may be operated so that an optimal data service may be provided to the terminal 10. To this end, the heterogeneous network mobility management entity 122 may figure out a rate system, a preferable communication scheme, and the like, on the basis of subscriber information of the terminal 10, and determine a communication scheme of the terminal 10 on the basis of the rate system and the preferable communication scheme. In addition, the heterogeneous network mobility management entity 122 may inspect packets transmitted from the CN 200 to determine a data transmission path up to the terminal 10 optimized for a service such as voice call, streaming, web browsing, or the like.

The heterogeneous network mobility management entity 122 may perform a quality of service (QoS) control function so as to consistently maintain a QoS between heterogeneous networks when the terminal 10 changes a radio access scheme.

In addition, the heterogeneous network mobility management entity 122 may perform a load balancing function of deciding a radio access situation and a network situation and determining a radio access scheme in which the terminal 10 may receive an optimal service. That is, the heterogeneous network mobility management entity 122 may monitor that traffics are concentrated in a specific radio access scheme, and determine an optimal radio access scheme or add a new network path in order to prevent generation of interference or an increase in packet delay during radio access.

In addition, the heterogeneous network mobility management entity 122 may perform a performance evaluator function of confirming performance of a service provided to the terminal 10 and selecting a radio access scheme capable of providing a better service. That is, the terminal 10 may efficiently perform network switching to the radio access scheme capable of providing the better service through the performance evaluator function of the heterogeneous network mobility management entity 122.

Referring to FIG. 3, the heterogeneous network mobility management entity 122 determines that a mmWave network is a network optimal for the first terminal, and determines that an LTE network is a network optimal for the second terminal.

Hereinafter, the method for managing mobility of a terminal of a heterogeneous network base station 100 will be described with reference to FIG. 4.

First, a plurality of terminals 10 measure channel states of radio access networks on the basis of radio access capability (S101). In this case, the plurality of terminals 10 include multi-mode and multi-RAT functions. Since the plurality of terminals 10 include the multi-mode function, the plurality of terminals 10 may measure channel states of radio networks that they are currently accessing and states of radio channels that are accessible through the multi-mode function. In addition, a measurement interval for measuring the channel states by the plurality of terminals 10 may be set to any time or be the same as a measurement interval depending on a currently accessed radio access specification. Then, the plurality of terminals 10 transfer identifications (IDs) of the terminals, information on channels that may be measured by the terminals, and radio channel measurement data, which are a measurement result of radio channel states, to the RUs 300 through a current access scheme (S102).

The RUs 300 collect data on radio channels (radio channel data) from the plurality of terminals 10 (S103). In addition, the RUs 300 measure an average value of radio resources (average radio resource data) used in the RUs 300 (S104). In this case, the average radio resource data used in the RUs 300 may be an average received signal strength indication (RSSI), an average signal interference plus noise ratio (SINR), or the like. In this case, average channel characteristics of the RUs 300 may be measured on the basis of the average radio resource data in the RUs 300.

In addition, the RUs 300 measure a congestion or delay situation of a network (S105). Since the congestion situation of the network may become a very sensitive problem when data are transmitted at a gigabyte level in 5G mobile communication, the RUs 300 measure congestion and delay situations of data of the RUs 300.

Then, the RUs 300 transfer the radio channel measurement data measured in the plurality of terminals 10, the average radio resource data, which are an average value of the radio resources of the RUs 300, and network congestion data, which are a measurement result of a network congestion situation, to the heterogeneous network resource management entity 121 (S106).

Meanwhile, the heterogeneous network resource management entity 121 generates applications corresponding to the plurality of terminals 10 and the RUs 300 of a plurality of heterogeneous networks in order to manage resource situations of the plurality of terminals 10 and the RUs 300 of the plurality of heterogeneous networks (S107). That is, the heterogeneous network resource management entity 121 may manage data on radio resources of the terminals 10 and the RUs 300 (radio channel data of the terminals, average radio resource data of the RUs 300, network congestion data, and the like) through the applications each corresponding to the terminals 10 and the RUs 300. In addition, the radio channel data measured in the plurality of terminals 10, the average radio resource data of the RUs 300, and the network congestion data are periodically transferred to the heterogeneous network mobility management entity 122 through the applications corresponding to the terminals 10 and the RUs 300 (S108).

The heterogeneous network mobility management entity 122 collects the resource data (for example, the radio channel data, the average radio resource data, and the like) of the plurality of terminals 10 and the RUs 300 of the plurality of heterogeneous networks from the heterogeneous network resource management entity 121, and decides whether or not to need to change networks connected to the respective terminals (S109). When the heterogeneous network mobility management entity 122 decides whether or not to change the networks of the terminals 10, the heterogeneous network mobility management entity 122 may refer to inspection results of the packets transmitted to the terminals 10. In addition, when the heterogeneous network mobility management entity 122 decides whether or not to change the networks of the terminals 10, the heterogeneous network mobility management entity 122 may refer to a situation of the network currently connected to the terminal and situations of other networks in a zone in which the terminals 10 are positioned on the basis of the network congestion data.

When the networks connected to the terminals need to be changed, the heterogeneous network mobility management entity 122 instructs the terminals 10 to change the networks into optimal networks on the basis of subscriber information and optimal paths of the terminals 10 (S110), and the networks connected to the terminals 10 are changed between the terminals 10 and the heterogeneous network resource management entity 121 (S111). The change of the networks may depend on a network access or change scheme (random access, handover, or the like) of conventional radio access specifications. In this case, the heterogeneous network mobility management entity 122 may additionally set network paths of heterogeneous networks in order to smooth transmission of data to the terminals 10.

In addition, handover between the heterogeneous networks may be performed within the CN 200. Therefore, the terminal 10 may perform the handover between the heterogeneous networks by changing only the DUs of the application layer 120 while maintaining a bearer and a session. When the terminals 10 need to additionally generate other radio access type bearers and sessions, the terminals 10 and the CN 200 may generate contexts of new bearers or sessions to add the bearers or the sessions.

Since QoS control schemes unique to the respective radio networks are present in the respective radio networks, the heterogeneous network mobility management entity 122 changes a QoS control scheme of a conventional network so as to be appropriate for a new network at the time of changing the network. The heterogeneous network mobility management entity 122 may change the networks connected to the terminals 10 after adjustment of the QoS control scheme depending on the change of the radio access scheme.

The heterogeneous network base station 100 according to an exemplary embodiment as described above provides an optimal QoS to a user and provides offloading of radio data, or the like, thereby making it possible to optimize a radio communication network. In addition, in terms of control plane (CP) signaling, existing non-access stratum (NAS) setting is used as it is, such that an amount of CP messages may be significantly decreased and a delay of the CP messages may be decreased. In terms of user plane (UP) signaling, data may be simultaneously transmitted in different communication schemes through one integrated bearer management, such that a transmission capacity may also be increased.

According to an exemplary embodiment, non-access stratums (NASs) of the respective mobile communication networks are implemented to be the same as each other, and management of mobility of a terminal and management of radio resources in a heterogeneous network radio communication environment may be easily performed. In addition, when handover to another mobile communication network is required, a terminal may change only a radio access scheme while using existing network-based bearer setting as it is.

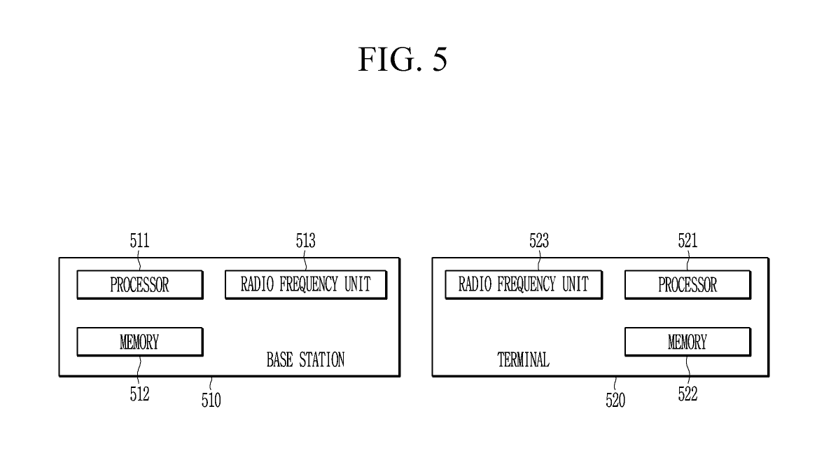

FIG. 5 is a block diagram showing a radio communication system according to an exemplary embodiment.

Referring to FIG. 5, the radio communication system according to an exemplary embodiment includes a base station 510 and a terminal 520.

The base station 510 includes a processor 511, a memory 513, and a radio frequency unit (RF unit) 513. The memory 512 may be connected to the processor 511 to store various kinds of information for driving the processor 511 or at least one program executed by the processor 511 therein. The radio frequency unit 513 may be connected to the processor 511 to transmit/receive radio signals to/from the processor 511. The processor 511 may implement functions, processes, or methods suggested in an exemplary embodiment of the present invention. Here, in the radio communication system according to an exemplary embodiment of the present invention, a radio interface protocol layer may be implemented by the processor 511. An operation of the base station 510 according to an exemplary embodiment may be implemented by the processor 511.

The terminal 520 includes a processor 521, a memory 522, and a radio frequency unit 523. The memory 522 may be connected to the processor 521 to store various kinds of information for driving the processor 521 or at least one program executed by the processor 521 therein. The radio frequency unit 523 may be connected to the processor 521 to transmit/receive radio signals to/from the processor 521. The processor 521 may implement functions, steps, or methods suggested in an exemplary embodiment of the present invention. Here, in the radio communication system according to an exemplary embodiment of the present invention, a radio interface protocol layer may be implemented by the processor 521. An operation of the terminal 520 according to an exemplary embodiment may be implemented by the processor 521.

In an exemplary embodiment of the present invention, the memory may be positioned inside or outside the processor, and may be connected to the processor through various means that are well-known. The memory may be various types of volatile or non-volatile storage medium, and may include, for example, a read-only memory (ROM) or a random access memory (RAM).

Although the exemplary embodiment of the present invention has been described in detail hereinabove, the scope of the present invention is not limited thereto. That is, several modifications and alterations made by those skilled in the art using a basic concept of the present invention as defined in the claims fall within the scope of the present invention.

What is claimed is:

1. A method for managing mobility of a terminal between heterogeneous networks, the method comprising:
generating applications each corresponding to a plurality of terminals and data units (DUs) of a plurality of heterogeneous networks using software defined network (SDN) technology;
collecting radio channel measurement data on channels of radio networks from the plurality of terminals through terminal applications corresponding to the plurality of terminals;
collecting an average value of radio resources used in radio units (RUs) of the plurality of heterogeneous networks and network congestion data of the RUs of the plurality of heterogeneous networks through DU applications corresponding to the DUs of the plurality of heterogeneous networks; and
determining whether or not to change networks of the plurality of terminals on the basis of the radio channel measurement data, the average value of the radio resources, and the network congestion data.

2. The method for managing mobility of claim 1, wherein the determining of whether or not to change the networks includes referring to inspection results of packets transmitted to the plurality of terminals.

3. The method for managing mobility of claim 1, wherein the determining of whether or not to change the networks includes referring to a situation of a network currently connected to one of the plurality of terminals and situations of other networks in a zone in which the plurality of terminals are positioned on the basis of the network congestion data.

4. The method for managing mobility of claim 1, further comprising:
after the determining of whether or not to change the networks, instructing a first terminal that is to change a network among the plurality of terminals to change the network into an optimal network on the basis of subscriber information and an optimal path of the first terminal.

5. The method for managing mobility of claim 1, further comprising:
after the determining of whether or not to change the networks, adjusting a quality of service (QoS) control scheme to a QoS control scheme of a new network into which the network is to be changed.

6. The method for managing mobility of claim 1, further comprising:
after the determining of whether or not to change the networks, adding a network path of a network different from a network currently connected to a first terminal that is to change a network among the plurality of terminals with respect to the first terminal.

7. A heterogeneous network base station comprising:
a processor, a memory, and a radio frequency unit,
wherein the processor executes a program stored in the memory to perform the following steps:
generating applications each corresponding to a plurality of terminals and DUs of a plurality of heterogeneous networks using SDN technology;
collecting radio channel measurement data on channels of radio networks from the plurality of terminals through terminal applications corresponding to the plurality of terminals;
collecting an average value of radio resources used in RUs of the plurality of heterogeneous networks and network congestion data of the RUs of the plurality of heterogeneous networks through DU applications corresponding to the DUs of the plurality of heterogeneous networks; and
determining whether or not to change networks of the plurality of terminals on the basis of the radio channel measurement data, the average value of the radio resources, and the network congestion data.

8. The heterogeneous network base station of claim 7, wherein:
when the processor performs the determining of whether or not to change the networks, the processor performs the following step:
referring to inspection results of packets transmitted to the plurality of terminals.

9. The heterogeneous network base station of claim 7, wherein:
when the processor performs the determining of whether or not to change the networks, the processor performs the following step:
referring to a situation of a network currently connected to one of the plurality of terminals and situations of other networks in a zone in which the plurality of terminals are positioned on the basis of the network congestion data.

10. The heterogeneous network base station of claim 7, wherein:
the processor executes the program to further perform the following step:
after the determining of whether or not to change the networks, instructing a first terminal that is to change a network among the plurality of terminals to change the network into an optimal network on the basis of subscriber information and an optimal path of the first terminal.

11. The heterogeneous network base station of claim 7, wherein:
the processor executes the program to further perform the following step:
after the determining of whether or not to change the networks, adjusting a QoS control scheme to a QoS control scheme of a new network into which the network is to be changed.

12. The heterogeneous network base station of claim 7, wherein:
the processor executes the program to further perform the following step:
after the determining of whether or not to change the networks, adding a network path of a network different from a network currently connected to a first terminal that is to change a network among the plurality of terminals with respect to the first terminal.

13. An apparatus for managing mobility of a terminal between heterogeneous networks, the apparatus comprising:
a network function virtualization (NFV) infrastructure layer connecting a plurality of hardware resources including computing hardware, storage hardware, and network hardware and a plurality of virtual network functions (VNFs) including virtual computing, a virtual storage, and a virtual network to each other through a virtualization layer to virtualize network functions;
an application layer including applications each corresponding to a plurality of terminals and DUs of a plurality of heterogeneous networks using SDN technology; and
a virtual network functions (VNFs) layer performing interfacing between the NFV infrastructure layer and the application layer,
wherein the application layer includes:
a heterogeneous network resource management entity collecting radio channel measurement data on channels of radio networks from the plurality of terminals through terminal applications corresponding to the plurality of terminals and collecting an average value of radio resources used in radio units (RUs) of the plurality of heterogeneous networks and network congestion data of the RUs of the plurality of heterogeneous networks through DU applications corresponding to the DUs of the plurality of heterogeneous networks; and
a heterogeneous network mobility management entity determining whether or not to change networks of the plurality of terminals on the basis of the radio channel measurement data, the average value of the radio resources, and the network congestion data.

14. The apparatus for managing mobility of claim 13, wherein the heterogeneous network mobility management entity determines whether or not to change the networks with reference to inspection results of packets transmitted to the plurality of terminals.

15. The apparatus for managing mobility of claim 13, wherein the heterogeneous network mobility management entity determines whether or not to change the networks with reference to a situation of a network currently connected to one of the plurality of terminals and situations of other networks in a zone in which the plurality of terminals are positioned on the basis of the network congestion data.

16. The apparatus for managing mobility of claim 13, wherein:
the heterogeneous network mobility management entity,
after the determining of whether or not to change the networks, instructs a first terminal that is to change a network among the plurality of terminals to change the network into an optimal network on the basis of subscriber information and an optimal path of the first terminal.

17. The apparatus for managing mobility of claim 13, wherein:
the heterogeneous network mobility management entity,
after the determining of whether or not to change the networks, adjusts a QoS control scheme to a QoS control scheme of a new network into which the network is to be changed.

18. The apparatus for managing mobility of claim 13, wherein:
the heterogeneous network mobility management entity,
after the determining of whether or not to change the networks, adds a network path of a network different from a network currently connected to a first terminal that is to change a network among the plurality of terminals with respect to the first terminal.
